(19) United States
(12) Patent Application Publication
(10) Pub. No.: US 2026/0119862 A1
(43) Pub. Date: Apr. 30, 2026

(54) ARTIFICIAL NEURAL NETWORK APPARATUS AND METHOD FOR OPERATING THE SAME

(71) Applicants: Hyundai Motor Company, Seoul (KR); Kia Corporation, Seoul (KR); Gwangju Institute of Science and Technology, Gwangju (KR)

(72) Inventors: Sang-Hyeok YANG, Hwaseong-Si (KR); Hyunsoo KIM, Hwaseong-Si (KR); Byung-Geun LEE, Gwangju (KR); Do Won KIM, Gwangju (KR)

(73) Assignees: Hyundai Motor Company, Seoul (KR); Kia Corporation, Seoul (KR); Gwangju Institute of Science and Technology, Gwangju (KR)

(21) Appl. No.: 19/370,495

(22) Filed: Oct. 27, 2025

(30) Foreign Application Priority Data
Oct. 30, 2024 (KR) 10-2024-0150365

(51) Int. Cl. G06N 3/065

(52) U.S. Cl. CPC G06N 3/065

(57) ABSTRACT

Provided are an artificial neural network apparatus and a method for operating the same. The artificial neural network apparatus may include: a synaptic device; an integrator operatively connected to the synaptic device and integrating a current generated based on that an input pulse voltage is applied to the synaptic device into a voltage, and outputting a first voltage; a ramp generator operatively connected to the integrator and generating a ramp signal based on the first voltage and a second voltage output from a digital-analog converter; and an output circuit operatively connected to the ramp generator and storing an output of the ramp generator and transmitting the output to the outside.

### CROSS-REFERENCE TO RELATED APPLICATION

This application claims priority to and the benefit of Korean Patent Application No. 10-2024-0150365 filed in the Korean Intellectual Property Office on Oct. 30, 2024, the entire contents of which are incorporated herein by reference.

### BACKGROUND

### Technical Field

The present disclosure relates to an artificial neural network apparatus and a method for operating the same, and more particularly, to an apparatus that implements an artificial neural network system that simulates a human brain as hardware, and a method for operating the same.

### Description of the Related Art

An artificial neural network system may be implemented by a circuit that simulates a human neural network when performing a “training” or “inference” operation that requires processing of a large amount of artificial intelligence data. Specifically, the artificial neural network system may include a synapse that stores and computes an input signal, and a neuron circuit that receives an analog signal generated from the synapse and converts and transmits the analog signal to a digital domain.

An activation function may be implemented in a digital manner. However, in this case, an output of an analog-to-digital converter is utilized, which may involve high computational energy consumption and occupy significant space on an integrated circuit. As a solution to such a problem, a method using a probabilistic neuron that implements the activation function without the analog-to-digital converter has emerged, but the probabilistic neuron does not resolve a tradeoff between a computational time and computational accuracy of the activation function. In particular, there is a limitation that such a method may not be applied to a training method (ex-situ training) based on weight transfer that requires the analog-to-digital converter with high computational accuracy required in an artificial neural network apparatus.

### SUMMARY

The present disclosure attempts to provide an artificial neural network apparatus that implements an activation function and a neuron used in an artificial neural network as an integrated circuit (IC), and a method for operating the same.

The present disclosure attempts to provide an artificial neural network apparatus that implements an activation function and a neuron in an analog manner and includes an analog-to-digital converter that reads an analog signal such as an output current from a synaptic device such as a resistive random access memory (RRAM), and a method for operating the same.

An artificial neural network apparatus according to an exemplary embodiment includes: a synaptic device; an integrator operatively connected to the synaptic device and integrating a current generated when an input pulse voltage is applied to the synaptic device into a voltage, and outputting a first voltage; a ramp generator operatively connected to the integrator and generating a ramp signal based on the first voltage and a second voltage output from a digital-analog converter; and an output circuit operatively connected to the ramp generator and storing an output of the ramp generator and transmitting the output to an outside.

The synaptic device may include a resistive random access memory (RRAM) cross-bar array structure.

The ramp generator may output both a ramp signal modified for an activation function and a ramp signal for implementing an analog-digital converter for training.

The output circuit may include a counter and a serializer.

The ramp generator may include: a comparator comparing the first voltage and the second voltage and outputting a pulse signal; and an asynchronous logic circuit asynchronously generating the ramp signal by using the pulse signal provided from the comparator.

The ramp generator may further include: a counter outputting a digital signal that increases by 1 in binary by using an asynchronous signal generated from the asynchronous logic circuit; and the digital-analog converter receiving the digital signal indicating a binary value of the counter and converting the digital signal into an analog voltage signal.

The pulse signal output from the comparator may be input to a counter of the output circuit.

The first voltage may have a fixed value, and the second voltage may have a variable value.

An artificial neural network apparatus according to an exemplary embodiment includes: an integrator and integrating a current generated when an input pulse voltage is applied to a synaptic device into a voltage, and outputting a first voltage; a comparator operatively connected to the integrator and comparing the first voltage and a second voltage output from a digital-analog converter; a first counter operatively connected to the comparator and receiving an inverted signal for a first signal of a first output node among two output nodes of the comparator, and calculating a number of comparisons corresponding to a case where the first voltage is higher than the second voltage, relative to a total number of comparisons between the first voltage and the second voltage; and a serializer operatively connected to the first counter and serializing an output of the first counter.

The artificial neural network apparatus may further include: a first logic gate performing an AND logic operation on signals of two output nodes of the comparator and outputting a second signal; an asynchronous logic circuit receiving the second signal and generating a third signal, a fourth signal, and a fifth signal; and a second counter generating a digital output changing an output voltage of the digital-analog converter.

The third signal, the fourth signal, and the fifth signal may sequentially operate the second counter, the digital-analog converter, and the comparator, respectively.

The third signal may change the digital output of the second counter, and the digital output of the second counter may be input to the digital-analog converter to change the output voltage of the digital-analog converter.

The fourth signal may be generated at a timing later than a timing at which the third signal is generated by a delay circuit, and a rising edge of the fourth signal may activate the digital-analog converter to change the second voltage.

A rising edge of the fifth signal may occur after the second voltage of the digital-analog converter changes, and the rising edge of the fifth signal may trigger comparison between the first voltage and the second voltage.

The total number of comparisons between the first voltage and the second voltage may be determined depending on a resolution of an analog-to-digital converter or a resolution of an activation function.

The number of comparisons may be recognized by calculating a number of falling edges of the second signal by using the third counter.

In a case where an output of the third counter reaches a predetermined total number of comparisons, operations of the comparator, the asynchronous logic circuit, and the digital-to-analog converter may be stopped.

The asynchronous logic circuit may further include: a pulse signal generation circuit generating a pulse signal according to a predefined activation signal; and a second logic gate receiving an output signal of the pulse signal generation circuit as a first input thereof, receiving the second signal as a second input thereof, performing an OR logic operation, and outputting a sixth signal, in which the sixth signal is input to a first delay gate, a seventh signal is output from the first delay gate after a predetermined delay time, the sixth signal is input to a second delay gate, and an eighth signal is output from the second delay gate after a predetermined delay time.

The asynchronous logic circuit may further include: a first flip-flop receiving a third voltage through a D terminal, receiving the sixth signal through a clock terminal, and outputting a ninth signal; a second flip-flop receiving a ninth voltage through a D terminal, receiving the seventh signal through a clock terminal, and outputting a tenth signal; and a fourth flip-flop receiving a tenth voltage through a D terminal, receiving the eighth signal through a clock terminal, and outputting the fifth signal.

The asynchronous logic circuit may further include: a third logic gate receiving the ninth signal as a first input thereof, receiving an inverted signal for the tenth signal as a second input thereof, performing an AND logic operation, and outputting the third signal; and a fourth logic gate receiving the tenth signal as a first input thereof, receiving an inverted signal for the fifth signal as a second input thereof, performing an AND logic operation, and outputting the fourth signal.

### BRIEF DESCRIPTION OF THE DRAWINGS

FIG. 1 is a diagram for describing an artificial neural network apparatus according to an exemplary embodiment;

FIG. 2 is a diagram for describing the artificial neural network apparatus according to the exemplary embodiment;

FIG. 3 is a diagram for describing the artificial neural network apparatus according to the exemplary embodiment;

FIG. 4 is a diagram for describing an operation of the artificial neural network apparatus according to the exemplary embodiment;

FIG. 5 is a diagram for describing the artificial neural network apparatus according to the exemplary embodiment;

FIG. 6 is a diagram for describing the artificial neural network apparatus according to the exemplary embodiment;

FIG. 7 is a diagram for describing the artificial neural network apparatus according to the exemplary embodiment;

FIG. 8 is a diagram for describing the artificial neural network apparatus according to the exemplary embodiment;

FIG. 9 is a diagram for describing a method for operating the artificial neural network apparatus according to the exemplary embodiment; and

FIG. 10 and FIG. 11 are diagrams for describing the artificial neural network apparatus according to the exemplary embodiment of the present disclosure.

### DETAILED DESCRIPTION

Hereinafter, embodiments of the present disclosure will be described more fully with reference to the accompanying drawings so as to be easily practiced by those skilled in the art to which the present disclosure pertains. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the present specification and the claims, unless explicitly described to the contrary, the word “comprise” and variations such as “comprises” or “comprising”, will be understood to imply the inclusion of stated elements but not the exclusion of any other elements. Terms including an ordinal number such as first and second may be used to describe various components, but these components are not limited by these terms. These terms are used only for the purpose of distinguishing one component from another component.

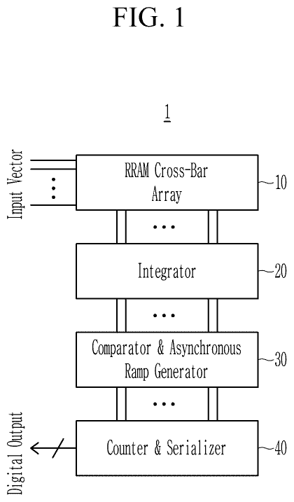

FIG. 1 is a diagram for describing an artificial neural network apparatus according to an exemplary embodiment of the present disclosure.

Referring to FIG. 1, an artificial neural network apparatus 1 according to an exemplary embodiment may include a synaptic device 10, an integrator 20, a ramp generator 30, and an output circuit 40.

The synaptic device 10 may include a cross-bar array structure such as a resistive random access memory (RRAM). The structure is a structure in which vertical and horizontal lines intersect in a grid shape, an RRAM cell is positioned at each intersection, and the RRAM cell may include a resistive material inserted between two electrodes. The RRAM cell may be in a high resistance state and a low resistance state depending on a voltage applied between the two electrodes. A synapse may mean a connection between neurons, and the RRAM may be adopted as the synaptic device to store and adjust a weight value during training and inference processes of an artificial neural network.

The integrator 20 may integrate a current generated when an input pulse voltage is applied to the synaptic device 10 into a voltage. Specifically, the integrator 20 may integrate a current received as an input signal from the synaptic device over time to generate an output signal corresponding to a voltage. To this end, the integrator 20 may include an operational amplifier (op-amp) for amplifying or processing the input signal with a predetermined gain. In addition, the integrator 20 may further include a capacitor for forming a feedback path between an output and an input of the operational amplifier. When the input signal, that is, the current output from the synaptic device 10, flows through the capacitor, the capacitor accumulates a charge, and the operational amplifier may generate an output voltage according to the charge accumulated in the capacitor.

The ramp generator 30 may asynchronously generate a modified ramp signal to implement an activation function and an analog-to-digital converter used in the artificial neural network. In particular, the ramp generator 30 may generate not only the ramp signal modified for the activation function, but also a ramp signal for implementing the analog-to-digital converter for training. The ramp generator 30 may asynchronously generate all the ramp signals at a high speed.

The output circuit 40 may be an output digital circuit that stores an output of the ramp generator 30 and transmits a result to the outside, and may include a counter and a serializer. The counter may increase or decrease a current state by 1 each time a clock signal received as an input changes. The serializer may provide serial data by sequentially outputting multiple bits of parallel data received as an input, one bit at a time.

In the present embodiment, the artificial neural network apparatus may be in the form of a neuron integrated circuit (IC) that converts an output current from the synaptic device 10 into a digital signal, and the number of circuits included in the integrated circuit may vary depending on an array size of the cross-bar-shaped synaptic device 10. In addition, digital output resolutions of the ramp generator 30, the counter, and the serializer may also vary depending on an input dataset or performance targeted by the artificial neural network.

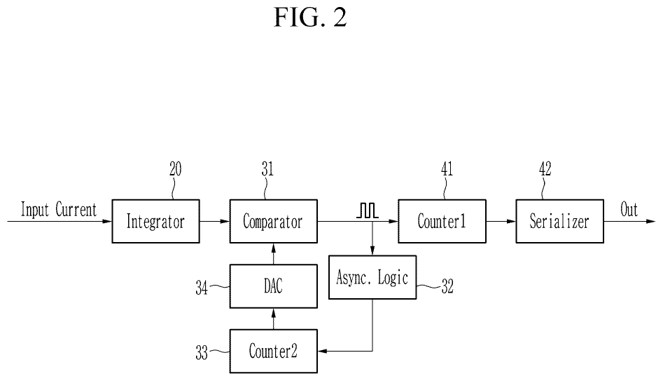

FIG. 2 is a diagram for describing the artificial neural network apparatus according to the exemplary embodiment of the present disclosure.

Referring to FIG. 2, the artificial neural network apparatus according to the exemplary embodiment may include the integrator 20, a comparator 31, an asynchronous logic circuit 32, counters 33 and 41, a digital-to-analog converter (DAC) 34, and a serializer 42. Here, the integrator 20 may correspond to the integrator 20 described above with reference to FIG. 1, the comparator 31, the asynchronous logic circuit 32, the counter 33, and the digital-to-analog converter 34 may correspond to the ramp generator 30 described above with reference to FIG. 1, and the counter 41 and the serializer 42 may correspond to the output circuit 40 described above with reference to FIG. 1.

The asynchronous logic circuit 32 may asynchronously generate a ramp signal by using a pulse signal provided from the comparator 31. The counter 33 may output a digital signal that increases by 1 in binary by using an asynchronous signal generated from the asynchronous logic circuit 32. The digital-to-analog converter 34 may receive the digital signal representing a binary number from the counter 33 and convert the digital signal into an analog voltage signal. An output voltage of the digital-to-analog converter 34 may be generated as a ramp signal modified according to a form of a digital output signal of the counter 33, and the comparator 31 may compare a magnitude of the output voltage of the digital-to-analog converter 34 with that of an output voltage of the integrator 20. The pulse signal output from the comparator 31 may also be input to the counter 41 of the output circuit 40, and a signal output by the counter 41 may mean a digital output signal of the activation function or the analog-to-digital converter. The serializer 42 may serialize an output digital binary signal generated in parallel by the counter 41 and transmit the serialized signal to the outside.

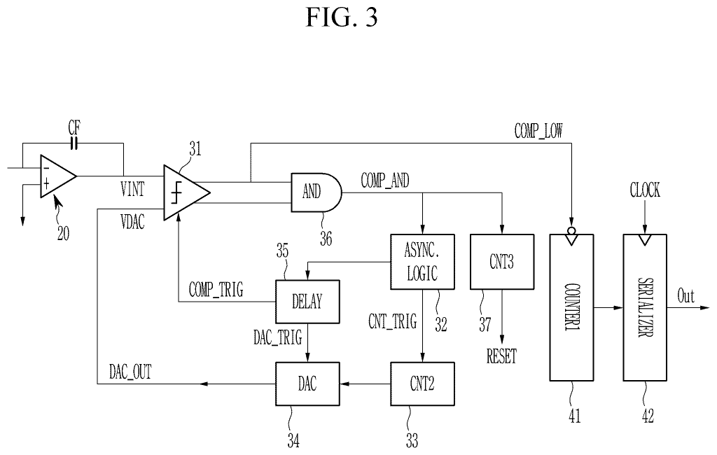

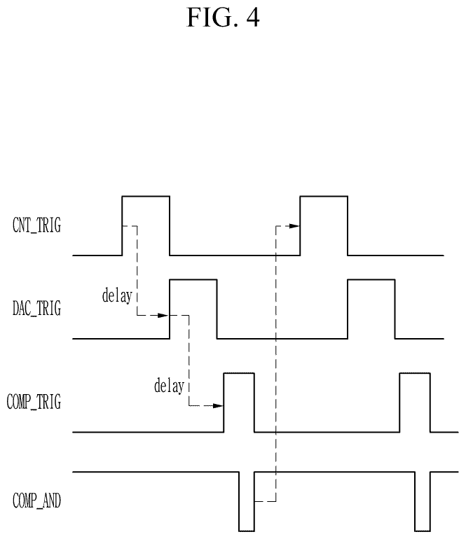

FIG. 3 is a diagram for describing the artificial neural network apparatus according to the exemplary embodiment of the present disclosure. FIG. 4 is a diagram for describing an operation of the artificial neural network apparatus according to the exemplary embodiment of the present disclosure.

Referring to FIG. 3, the artificial neural network apparatus according to the exemplary embodiment may include the integrator 20, the comparator 31, the asynchronous logic circuit 32, counters 33, 37, and 41, the digital-to-analog converter 34, a delay circuit 35, a logic gate 36, and the serializer 42. Here, the integrator 20 may correspond to the integrator 20 described above with reference to FIG. 1, and the comparator 31, the asynchronous logic circuit 32, the counters 33 and 37, the digital-to-analog converter 34, the delay circuit 35, and the logic gate 36 may correspond to the ramp generator 30 described above with reference to FIG. 1, and the counter 41 and the serializer 42 may correspond to the output circuit 40 described above with reference to FIG. 1.

The current output from the synaptic device 10 described above in FIG. 1 may be accumulated in a feedback capacitor CF of the integrator 20, and the integrator 20 may output a voltage VINT through the operational amplifier according to a charge accumulated in the feedback capacitor CF. Here, the voltage VINT may be fixed to a certain magnitude. As such, the magnitude of the voltage VINT whose value is fixed and a magnitude of an output voltage VDAC of the digital-to-analog converter 34 whose value is variable may be repeatedly compared through the comparator 31.

The comparator 31 may have two output nodes. A signal COMP_LOW of a first output node among the two output nodes may become logically low in a case where the voltage VINT is higher than the voltage VDAC, and the counter 41 may receive an inverted signal for the signal COMP_LOW as an input. The counter 41 may calculate the number of comparisons corresponding to a case where the voltage VINT is higher than the voltage VDAC relative to the total number of comparisons for the voltage VINT and the voltage VDAC.

An output value of the counter 41 may mean a digital output of the activation function or may mean an analog-to-digital conversion output for training depending on a changing form of the voltage VDAC. A parallel output of the counter 41 may be serialized by the serializer 42. Unlike a circuit that is provided upstream and asynchronously operates, the serializer 42 may operate synchronously with a clock.

Next, an operation of asynchronously comparing the voltage VINT and the voltage VDAC will be described in detail. An operation of the comparator 31 may be activated by a rising edge of a signal COMP_TRIG. Before the operation is activated, both output nodes of the comparator 31 may be logically high, and after the operation is completed, one of the two output nodes of the comparator 31 may be logically high and the other node may be logically low. The logic gate 36 may be an AND gate and may receive signals from the two output nodes of the comparator 31. A signal COMP_AND output from the logic gate 36 may become logically low according to an AND operation when the operation of the comparator 31 is completed.

The signal COMP_AND may be applied to the asynchronous logic circuit 32. The asynchronous logic circuit 32 may generate a signal CNT_TRIG, a signal DAC_TRIG, and the signal COMP_TRIG. Here, the signal CNT_TRIG, the signal DAC_TRIG, and the signal COMP_TRIG may sequentially operate the counter 33, the digital-to-analog converter 34, and the comparator 31, respectively. In this regard, reference may be made to FIG. 4.

Specifically, the signal CNT_TRIG may change a digital output of the counter 33. The digital output of the counter 33 may be input to the digital-to-analog converter 34 to change the output voltage of the digital-to-analog converter 34. The signal DAC_TRIG may be generated at a later timing than a timing at which the signal CNT_TRIG is generated by the delay circuit 35. A rising edge of the signal DAC_TRIG may activate the digital-to-analog converter 34 to change the voltage VDAC which is the output of the digital-to-analog converter 34. The rising edge of the signal COMP_TRIG may occur after the output voltage VDAC of the digital-to-analog converter 34 changes. The rising edge of the signal COMP_TRIG may trigger comparison between the fixed voltage VINT and the changed voltage VDAC. Such a process may be repeated by a predetermined total number of comparisons. In some exemplary embodiments of the present disclosure, the total number of comparisons between the fixed voltage VINT and the changed voltage VDAC may be determined depending on a resolution of the analog-to-digital converter or a resolution of the activation function. The number of comparisons may be recognized by calculating a number of falling edges of the signal COMP_AND by using the counter 37. When an output of the counter 37 reaches the predetermined total number of comparisons, the operations of the comparator 31, the asynchronous logic circuit 32, and the digital-to-analog converter 34 may be stopped.

Such a process may be an asynchronous operation method, that is, a method in which the operation is performed by a signal without periodicity that is generated within the integrated circuit, rather than a method in which the operation is performed synchronously by a clock signal that is applied from outside the integrated circuit and has a fixed period. Accordingly, a circuit in the next stage may be operated immediately after an operation of a circuit in a certain stage is completed without time consumption due to a fixed operation signal period, thereby securing a high operation speed.

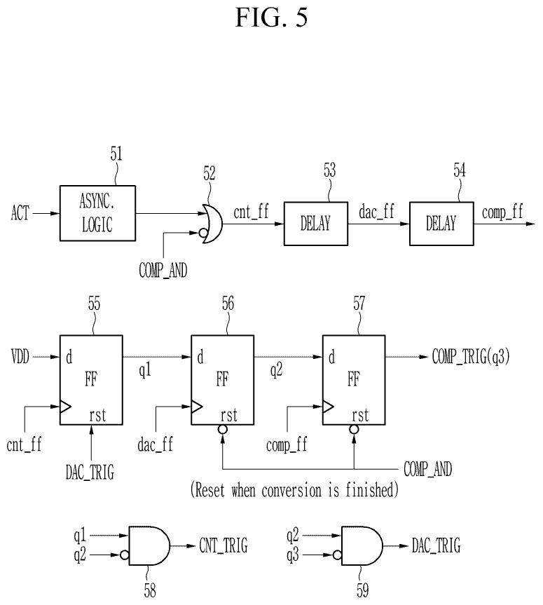

FIG. 5 is a diagram for describing the artificial neural network apparatus according to the exemplary embodiment of the present disclosure.

FIG. 5 illustrates an implementation example of the asynchronous logic circuit 32 according to the exemplary embodiment in FIG. 3. The asynchronous logic circuit 32 may include a pulse signal generation circuit 51, logic gates 52, 58, and 59, delay gates 53 and 54, and flip-flops 55, 56, and 57.

The pulse signal generation circuit 51 may generate a pulse signal according to a predefined activation signal ACT. The generated pulse signal may be input as a first input to the logic gate 52 that performs an OR logic operation. The logic gate 52 may receive an inverted signal for the signal COMP_AND as a second input thereof, and perform an OR logic operation on the first input and the second input to output a signal cnt_ff. The signal cnt_ff may be input to the delay gate 53, and a signal dac_ff may be output from the delay gate after a predetermined delay time. Subsequently, the signal dac_ff may be input to the delay gate 54, and a signal comp_ff may be output from the delay gate after a predetermined delay time.

The flip-flop 55 may receive a voltage VDD through a D terminal and receive the signal cnt_ff through a clock terminal. In addition, the flip-flop 55 may receive the signal DAC_TRIG through an rst terminal. The flip-flop 55 may output a signal q1. Next, the flip-flop 56 may receive the signal q1 through a D terminal and receive the signal dac_ff through a clock terminal. In addition, the flip-flop 56 may receive the inverted signal for the signal COMP_AND through an rst terminal. The flip-flop 56 may output a signal q2. Next, the flip-flop 57 may receive the signal q2 through a D terminal and receive the signal comp_ff through a clock terminal. In addition, the flip-flop 57 may receive the inverted signal for the signal COMP_AND through an rst terminal. The flip-flop 57 may output a signal q3. Here, the signal q3 may be the signal COMP_TRIG.

The logic gate 58 may receive the signal q1 as a first input and receive an inverted signal for the signal q2 as a second input. The logic gate 58 may perform an AND logic operation on the first input and the second input to output the signal CNT_TRIG. Meanwhile, the logic gate 59 may receive the signal q2 as a first input and receive an inverted signal for the signal q3 as a second input. The logic gate 59 may perform an AND logic operation on the first input and the second input to output the signal DAC_TRIG.

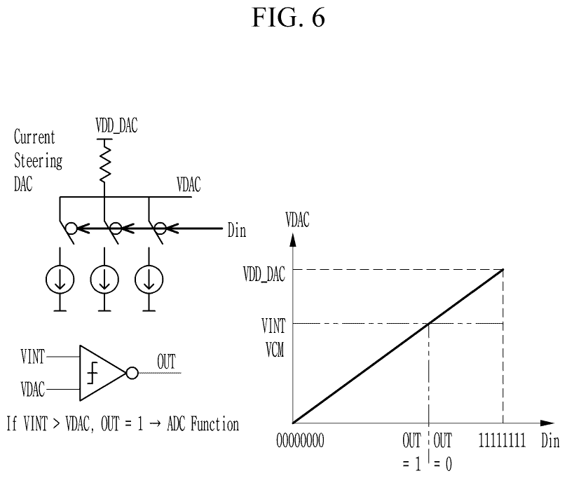

FIG. 6 is a diagram for describing the artificial neural network apparatus according to the exemplary embodiment of the present disclosure.

FIG. 6 illustrates that the output voltage of the digital-to-analog converter of the artificial neural network apparatus according to the exemplary embodiment generates the ramp signal in order to implement a function of the analog-to-digital converter.

The artificial neural network apparatus may provide the function of the analog-to-digital converter in a case where the voltage VINT is higher than the voltage VDAC. In some exemplary embodiments of the present disclosure, the digital-to-analog converter may include a current steering DAC. For example, when a resolution of the digital-to-analog converter is 8 bits, a digital binary input of the digital-to-analog converter may increase by 1 in binary from “00000000” to “11111111”. As a result, an analog output voltage may have a ramp shape. In a case where the output voltage VINT of the integrator is higher than the output voltage VDAC of the digital-to-analog converter, an inverted signal for an output of the comparator may continuously have a rising edge (OUT=1). At this time, the number of rising edges occurring relative to the total number of comparisons of the comparator may represent the analog output voltage of the integrator converted into a digital value.

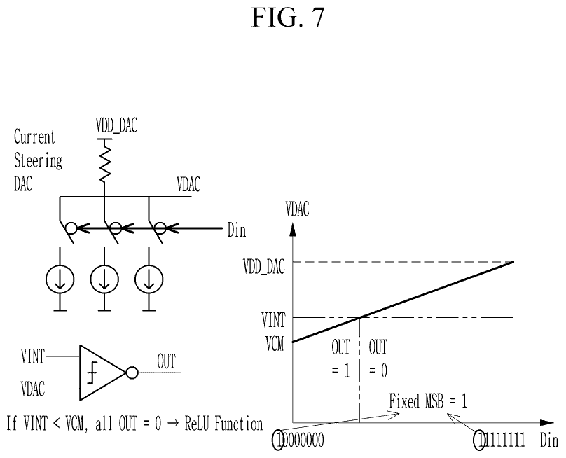

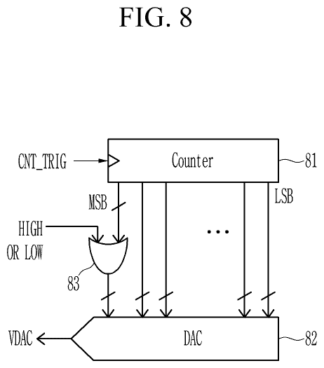

FIG. 7 is a diagram for describing the artificial neural network apparatus according to the exemplary embodiment of the present disclosure. FIG. 8 is a diagram for describing the artificial neural network apparatus according to the exemplary embodiment of the present disclosure.

FIG. 7 illustrates that the output voltage of the digital-to-analog converter of the artificial neural network apparatus according to the exemplary embodiment generates the modified ramp signal in order to implement the function of a rectified linear unit (ReLU) activation function.

The artificial neural network apparatus may provide the function of the ReLU activation function in a case where the voltage VINT is lower than the voltage VDAC. In some exemplary embodiments of the present disclosure, the digital-to-analog converter may include the current steering DAC. For example, when the resolution of the digital-to-analog converter is 8 bits, the digital binary input of the digital-to-analog converter may increase by 1 in binary from “10000000” to “11111111”. That is, the most significant bit (MSB) may be fixed to “1”, which is different from FIG. 6. From such a type of input, the output voltage of the digital-to-analog converter may appear in the form of the modified ramp signal that increases from a voltage value VCM corresponding to half of a full swing range to a supply voltage VDD_DAC.

Since the modified ramp signal always has a value higher than the voltage value VCM, the inverted signal for the comparator may always be logically low in a case where the output voltage VINT of the integrator is lower than the voltage value VCM. Therefore, when there is no input current from the synaptic device to the integrator, in a case where the output voltage of the integrator is set to be equal to the voltage value VCM, a digital conversion value of the voltage VINT may appear in the form of the ReLU activation function whose output is all 0 when an input is below a reference point (the VCM in a circuit perspective), and whose output is equal to the input when the input is above the reference point.

Referring to FIG. 8, since the modified ramp signal is generated by fixing only the MSB of a control signal Din of the digital-to-analog converter to 1, the function of the ReLU activation function may be simply implemented by adding an OR gate 83 to circuits such as a counter 81 and a digital-to-analog converter 82 for an operation as the analog-to-digital converter.

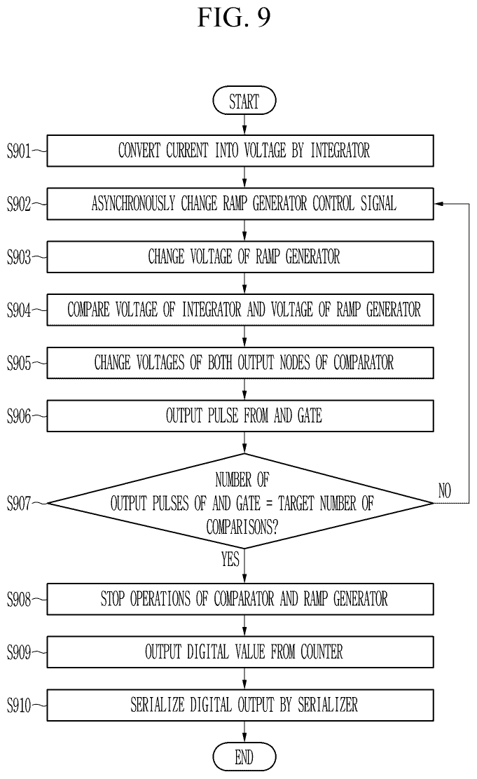

FIG. 9 is a diagram for describing a method for operating the artificial neural network apparatus according to the exemplary embodiment of the present disclosure.

Referring to FIG. 9, in the method for operating the artificial neural network apparatus according to the exemplary embodiment of the present disclosure, the integrator may store an output current from a synaptic device array in the feedback capacitor and convert the output current into a voltage. A magnitude of the output voltage of the integrator may not change when compared with the output voltage of the digital-to-analog converter. When the integrator completes conversion of the input current into the voltage, the output signal of the counter controlling the digital-to-analog converter may asynchronously change. Accordingly, the output voltage of the digital-to-analog converter may change. In the comparator, comparison in magnitude between the output voltage of the integrator and the output voltage of the digital-to-analog converter is performed, and when the comparison is completed, the AND gate that receives the signals from both output nodes of the comparator as inputs may generate an output pulse. The counter receiving the output pulse signal of the AND gate counts the number of the input signal. In a case where the number is equal to the total number of comparison operations of the comparator determined based on the resolution of the activation function or the analog-to-digital converter, the operations of the comparator and the ramp generator are stopped, and in a case where the number is smaller than the total number of comparison operations of the comparator determined based on the resolution of the activation function or the analog-to-digital converter, the operations of the ramp generator and the comparator may be repeated.

In some exemplary embodiments of the present disclosure, the method for operating the artificial neural network apparatus according to the exemplary embodiment may include: converting a current into a voltage in the integrator (S901); asynchronously changing a ramp generator control signal (S902); changing a voltage of the ramp generator (S903); comparing the voltage of the integrator and the voltage of the ramp generator (S904); changing voltages of both output nodes of the comparator (S905); outputting a pulse from the AND gate (S906); and determining whether or not the number of output pulses of the AND gate is equal to a predetermined target number of comparisons (S907).

In a case where it is determined that the number of output pulses of the AND gate is equal to the predetermined target number of comparisons (S907: “YES”), the method may perform stopping the operations of the comparator and the ramp generator (S908), outputting a digital value from the counter (S909), and serializing the digital output by the serializer (S910). Alternatively, in a case where it is determined that the number of output pulses of the AND gate is not equal to the predetermined target number of comparisons (S907: “NO”), the method may proceed to step (S902).

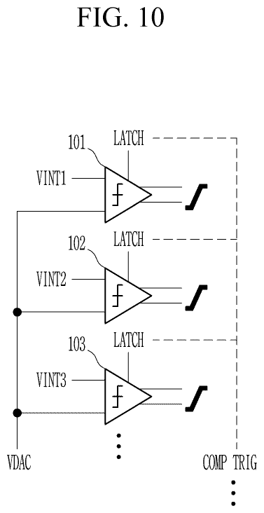

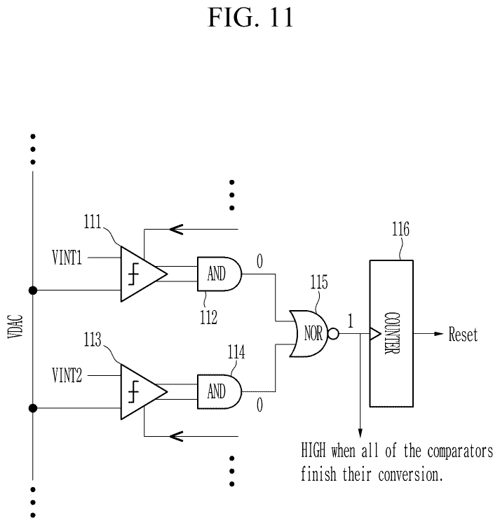

FIGS. 10 and 11 are diagrams for describing the artificial neural network apparatus according to the exemplary embodiment of the present disclosure.

The number of neuron circuits included in one integrated circuit may vary depending on the array size of the cross-bar-shaped synaptic device. Even when a plurality of neuron circuits form one integrated circuit, only one ramp generator is included, and only the number of integrators and the number of comparators may increase by the number of neuron circuits. An implementation example of a neuron circuit array in which a plurality of neuron circuits are integrated is as illustrated in FIGS. 10 and 11.

Referring to FIG. 10, comparator arrays 101, 102, and 103 share the output voltage of the digital-to-analog converter and may be operated according to the comparator operation signal COMP_TRIG from the asynchronous logic circuit. Here, the comparator arrays 101, 102, and 103 may be operated simultaneously according to the signal COMP_TRIG shared with each other or may be operated sequentially.

Referring to FIG. 11, the neuron circuit array may perform only detection of completion of comparison of all comparators 111 and 113 rather than calculation of the total number of comparisons of the comparator by adding a NOR gate 115 at a position downstream of AND gates 112 and 114 and upstream of a counter 116.

In some exemplary embodiments of the present disclosure, the asynchronous operation method according to the exemplary embodiments is not limited to a case where the output voltage of the digital-to-analog converter is the ramp signal, and the asynchronous operation method according to the exemplary embodiments may be applied even in a case where an input digital signal of the digital-to-analog converter is applied by another digital circuit designed according to a desired function rather than an output from the counter.

According to the exemplary embodiments described above, in a probabilistic neuron circuit method, the ReLU activation function is implemented by the asynchronous method to resolve a tradeoff between an operation time and operation accuracy and significantly reduce the operation time. In particular, it is possible to eliminate a waste of the operation time caused by a clock signal according to the related art with a fixed period by applying the asynchronous method, thereby further increasing the operation speed. As a result, a processing speed of the artificial neural network system may be increased, and more effective use may be achieved in real-time or near-real-time applications. In addition, the function of the analog-to-digital converter may be performed by a simple modification of an apparatus that implements the activation function. Selective application may be made in inference and weight value transfer training processes of the artificial neural network by implementing the functions of both the ReLU activation function and the analog-to-digital converter in this way.

Although the exemplary embodiment of the present disclosure has been described in detail hereinabove, the scope of the present disclosure is not limited thereto. That is, several modifications and alterations made by a person of ordinary skill in the art to which the present disclosure pertains using a basic concept of the present disclosure as defined in the claims fall within the scope of the present disclosure.

What is claimed is:

1. An artificial neural network apparatus comprising:
a synaptic device;
an integrator operatively connected to the synaptic device and integrating a current generated based on that an input pulse voltage is applied to the synaptic device into a voltage, and outputting a first voltage;
a ramp generator operatively connected to the integrator and generating a ramp signal based on the first voltage and a second voltage output from a digital-analog converter; and
an output circuit operatively connected to the ramp generator and storing an output of the ramp generator and transmitting the output to an outside.

2. The artificial neural network apparatus of claim 1, wherein the synaptic device includes a resistive random access memory (RRAM) cross-bar array structure.

3. The artificial neural network apparatus of claim 1, wherein the ramp generator outputs both a ramp signal modified for an activation function and a ramp signal for implementing an analog-digital converter for training.

4. The artificial neural network apparatus of claim 1, wherein the output circuit includes a counter and a serializer.

5. The artificial neural network apparatus of claim 1, wherein the ramp generator includes:
a comparator comparing the first voltage and the second voltage and outputting a pulse signal; and
an asynchronous logic circuit asynchronously generating the ramp signal by using the pulse signal provided from the comparator.

6. The artificial neural network apparatus of claim 5, wherein the ramp generator further includes:
a counter outputting a digital signal that increases by 1 in binary by using an asynchronous signal generated from the asynchronous logic circuit; and
the digital-analog converter receiving the digital signal indicating a binary value of the counter and converting the digital signal into an analog voltage signal.

7. The artificial neural network apparatus of claim 5, wherein the pulse signal output from the comparator is input to a counter of the output circuit.

8. The artificial neural network apparatus of claim 1, wherein the first voltage includes a fixed value, and the second voltage includes a variable value.

9. An artificial neural network apparatus comprising:
an integrator integrating a current generated based on that an input pulse voltage is applied to a synaptic device into a voltage, and outputting a first voltage;
a comparator operatively connected to the integrator and comparing the first voltage and a second voltage output from a digital-analog converter;
a first counter operatively connected to the comparator and receiving an inverted signal for a first signal of a first output node among two output nodes of the comparator, and calculating a number of comparisons corresponding to a case where the first voltage is higher than the second voltage, relative to a total number of comparisons between the first voltage and the second voltage; and
a serializer operatively connected to the first counter and serializing an output of the first counter.

10. The artificial neural network apparatus of claim 9, further comprising:
a first logic gate performing an AND logic operation on signals of the two output nodes of the comparator and outputting a second signal;
an asynchronous logic circuit receiving the second signal and generating a third signal, a fourth signal, and a fifth signal; and
a second counter generating a digital output changing an output voltage of the digital-analog converter.

11. The artificial neural network apparatus of claim 10, wherein the third signal, the fourth signal, and the fifth signal sequentially operate the second counter, the digital-analog converter, and the comparator, respectively.

12. The artificial neural network apparatus of claim 11, wherein the third signal changes the digital output of the second counter, and the digital output of the second counter is input to the digital-analog converter to change the output voltage of the digital-analog converter.

13. The artificial neural network apparatus of claim 11, wherein the fourth signal is generated at a timing later than a timing at which the third signal is generated by a delay circuit, and a rising edge of the fourth signal activates the digital-analog converter to change the second voltage.

14. The artificial neural network apparatus of claim 11, wherein a rising edge of the fifth signal occurs after the second voltage of the digital-analog converter changes, and the rising edge of the fifth signal triggers comparison between the first voltage and the second voltage.

15. The artificial neural network apparatus of claim 14, wherein the total number of comparisons between the first voltage and the second voltage is determined depending on a resolution of an analog-to-digital converter or a resolution of an activation function.

16. The artificial neural network apparatus of claim 15, wherein the number of comparisons is recognized by calculating a number of falling edges of the second signal by using a third counter.

17. The artificial neural network apparatus of claim 16, wherein in a case where an output of the third counter reaches a predetermined total number of comparisons, operations of the comparator, the asynchronous logic circuit, and the digital-to-analog converter are stopped.

18. The artificial neural network apparatus of claim 10, wherein the asynchronous logic circuit further includes:
a pulse signal generation circuit generating a pulse signal according to a predefined activation signal; and
a second logic gate receiving an output signal of the pulse signal generation circuit as a first input thereof, receiving the second signal as a second input thereof, performing an OR logic operation, and outputting a sixth signal,
wherein the sixth signal is input to a first delay gate, and a seventh signal is output from the first delay gate after a predetermined delay time,
wherein the sixth signal is input to a second delay gate, and an eighth signal is output from the second delay gate after a predetermined delay time.

19. The artificial neural network apparatus of claim 18, wherein the asynchronous logic circuit further includes:
a first flip-flop receiving a third voltage through a D terminal, receiving the sixth signal through a clock terminal, and outputting a ninth signal;
a second flip-flop receiving a ninth voltage through a D terminal, receiving the seventh signal through a clock terminal, and outputting a tenth signal; and
a fourth flip-flop receiving a tenth voltage through a D terminal, receiving the eighth signal through a clock terminal, and outputting the fifth signal.

20. The artificial neural network apparatus of claim 19, wherein the asynchronous logic circuit further includes:
a third logic gate receiving the ninth signal as a first input thereof, receiving an inverted signal for the tenth signal as a second input thereof, performing an AND logic operation, and outputting the third signal; and
a fourth logic gate receiving the tenth signal as a first input thereof, receiving an inverted signal for the fifth signal as a second input thereof, performing an AND logic operation, and outputting the fourth signal.
